(19) United States
(12) Patent Application Publication
(10) Pub. No.: US 2021/0029385 A1
(43) Pub. Date: Jan. 28, 2021

(54) INTERACTIVE SYSTEM AND METHOD FOR VIRTUAL RIDE-SHARING WITH ELECTRIC VEHICLE

(71) Applicant: Edward Lee, Irvine, CA (US)

(72) Inventor: Edward Lee, Irvine, CA (US)

(21) Appl. No.: 16/521,488

(22) Filed: Jul. 24, 2019

(51) Int. Cl. H04N 21/2187; B60L 50/60; B62J 99/00; B62K 11/10; B62K 11/14; H04N 21/4223; H04N 21/237

(52) U.S. Cl. CPC H04N 21/2187; B60L 50/60; B62J 99/00; B62K 11/10; B62J 6/02; H04N 21/4223; H04N 21/237; B60L 2240/70; B62K 2202/00; B62K 11/14

(57) ABSTRACT

An interactive system and method for virtual ride-sharing with electric vehicle allows a vehicle operator to operate the electric vehicle, like an electric scooter, while simultaneously interacting with network users to share a riding experience through a social media site and the Internet directly from the electric vehicle. An in-vehicle camera captures vehicle data and posts vehicle data to a social media site. The vehicle operator performs social networking functions like: uploading content, downloading content, posting riding images, livestreaming content, and interacting with others on social media while operating electric vehicle. The electric vehicle comprises a step-through frame and is operable as a plug-in electric vehicle having electricity stored on board in a rechargeable battery to drive an electric motor. The vehicle has a slim aesthetic design, an aerodynamic manual brake fin, a mobile communication device holder, and an accelerator handle and a brake handle differentiated by color.

### FIELD OF THE INVENTION

The present invention relates generally to an interactive system and method for virtual ride-sharing with electric vehicle. The interactive system and method allows a vehicle operator to operate the electric vehicle, such as an electric scooter, while simultaneously interacting with network users to share a riding experience through a social media site and the Internet directly from the electric vehicle; whereby an in-vehicle camera or mobile communication device captures vehicle data and posts the vehicle data to a network, such as a social media site and the Internet; whereby the vehicle data includes: images and videos of current and previous trips; trip information, including duration, fuel/energy consumption, distance traveled, destination; current vehicle location, infotainment features; streaming audio; in-vehicle photos; vehicle diagnostic information; and vehicle navigation system information; and whereby the interactive system further provides an interactive display screen and social networking functions are incorporated into the interactive display screen to generate output for display on social media sites and the Internet; and whereby the vehicle operator can perform social networking functions such as: uploading content, downloading content, posting riding images, livestreaming content, and interacting with others on social media and the Internet while operating the electric vehicle; and whereby the electric vehicle comprises a step-through frame and operable as a plug-in electric vehicle with two or three wheels, and having electricity stored on board in a rechargeable battery to drive an electric motor; whereby the electric vehicle provides structural novelty through use of: a slim aesthetic design with a glossy finish, a shield-shaped front frame member, an aerodynamic manual brake fin, a communication device support member, detachable decorative panels having with multiple colors and designs that cover a slim floor platform a front frame member, an electric motor operable in the wheels, a power (On/Off) digital locking system, and an accelerator handle and a brake handle differentiated by color; and whereby the electric vehicle provides novel wireless connectivity through use of: an integral computer, an integrated Wi-Fi hotspot, a daytime running lamp, a help button, a sound system that includes a speaker for audio navigation and general audio synchronization, a camera for livestream and/or social media synchronization, a video streaming device, a device charger, and an integral global positioning system; and whereby the wireless connectivity is controllable through a mobile communication device and the mobile communication device is in communication with the computer, the Wi-Fi hotspot, the speaker system, the camera, the help switch, and the global positioning system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Those skilled in the art will recognize that as social networking becomes more important, people spend more time using their mobile connectivity devices in the vehicle. Currently, an increasing number of people use their mobile devices to access social networks e.g., Facebook, Twitter, YouTube while driving their vehicle. The use of electronic devices, especially smart-phones, while driving can be highly distracting and potentially dangerous. Despite these dangers, however, people continue to use their devices in the car in a distracting manner while driving.

In many instances, vehicles include infotainment and navigation systems. These systems are generally provided with a display around which mechanical control elements are arranged to provide a user interface mounted in a dashboard of a vehicle for driver and front passenger access. The display combines at least some of the control elements into a touch panel display. With the ever growing popularity and commercial significance of online social media systems, vehicle drivers and passengers want to view or communicate with online social networks. Improved ease of use and improved integration of online social networking services with onboard vehicle systems can provide a more enjoyable and informative traveling experience for drivers and passengers.

Generally, electric vehicles include a bank of rechargeable batteries that propel the vehicle. While electric vehicles may be effective at supplying the motor with enough electricity to propel the vehicle through various power demand situations, the limited driving range and the long recharge time of the batteries are substantial drawbacks that limit the legitimacy of the electric vehicle as a practical solution to the current problem. It is known in the art that electric vehicles have a bank of batteries which provide power to drive an electric motor. However, the batteries must be recharged from time to time. This is typically done by plugging the batteries into an AC power outlet for some period of time to restore the depleted energy.

Generally, vehicles have a sound system and a security system. The sound system usually consists of an AM/FM radio, a cassette or CD (compact disk) player, an equalizer/amplifier, and speakers. The radio and player are arranged in a metal casing or housing that is mounted in a dashboard of the vehicle. Further, vehicles are being equipped with a navigation system that incorporates a global positioning system (GPS) receiver. The GPS receiver has an antenna to receive signals from a satellite network. The vehicle navigation system uses the satellite positioning signals to compute coordinates that locate the vehicle over the surface of the earth with regard to longitude, latitude, and altitude. Also, with the appropriate map software, the vehicle's location can then be shown on a map.

In many instances, cellular communications systems have been added to vehicles. These communications systems enable the vehicle driver or occupant to transact telephone calls from their vehicle. Some systems are voice controlled which permit the driver to initiate or receive calls while traveling without removing a hand from the driving wheel, or diverting the eyes from the operation of the vehicle.

Other proposals have involved electrical vehicles with connectivity to social media sites. The problem with these vehicles and media connections is that they do not allow for efficient uploading and livestreaming of the ride experience. Also, they do not provide Internet connectivity with an electric vehicle. Even though the above cited Internet connected vehicles meet some of the needs of the market, a an interactive system and method for virtual ride-sharing with electric vehicle. The interactive system and method allows a vehicle operator to operate the electric vehicle, such as an electric scooter, while simultaneously interacting with network users to share a riding experience through a social media site and the Internet directly from the electric vehicle, is still desired.

### SUMMARY

Illustrative embodiments of the disclosure are generally directed to an interactive system and method for virtual ride-sharing with electric vehicle. The interactive system and method allows a vehicle operator to operate the electric vehicle, such as an electric scooter, while simultaneously interacting with network users and sharing a riding experience through a social media site and the Internet directly from the electric vehicle.

In some embodiments, the interactive system provides an electric vehicle, such as an electric scooter, that is operable to be ridden by a vehicle operator. The electric vehicle provides an in-vehicle camera or mobile communication device that captures vehicle data and posts the vehicle data to a network, such as a social media site and the Internet. The vehicle data may include, without limitation, images and videos of current and previous trips; trip information; including duration; fuel consumption; distance traveled; destination; current vehicle location; infotainment features; streaming audio; in-vehicle photos; vehicle diagnostic information; and vehicle navigation system information. In some embodiments, the camera can be either in-vehicle, mounted or attached, and removable from the electric vehicle.

The interactive system and method further provides an interactive display screen that the vehicle operator can interact with to upload and livestream vehicle data to the network. The interactive display screen may have a computer, receiver, satellite transmitter and other communication devices used for transmitting data to a remote server or network.

Social networking functions are incorporated into the interactive display screen to generate output for display on social media sites and the Internet. The vehicle operator can perform social networking functions, including, uploading content, downloading content, posting riding images, livestreaming content, and interacting with others on social media and the Internet while operating the electric vehicle.

The method for virtual ride-sharing with an electric vehicle comprises an initial Step of mounting, by a vehicle operator, an electric vehicle, the electric vehicle comprising an electric motor, a step-through frame, a front frame member, a steering column, and a floor platform carrying at least two wheels operatively connected to the electric motor, the wheels rotatable to advance the electric vehicle.

The method may further comprise a Step of engaging an accelerator handle to actuate the electric motor, whereby the electric vehicle advances. A Step includes orienting an in-vehicle camera in a desired direction and position. In some embodiments, a Step comprises capturing a vehicle data through the in-vehicle camera, whereby the vehicle data shows operation of the electric vehicle.

Another Step includes monitoring, by the vehicle operator, the vehicle data through an interactive display screen, the interactive display screen operational on the front frame member or the steering column of the electric vehicle. In some embodiments, a Step may include uploading, through the interactive display screen, the vehicle data to a network. A Step comprises livestreaming the interactive display screen, the vehicle data to a network. A final Step includes viewing, by an observer, the vehicle data.

The structure of the electric vehicle may be that of a scooter, as known in the art. In one embodiment, the electric vehicle comprises a step-through frame that allows for easy riding. The step-through arrangement allows for easy one-easy off riding. The frame is also unique and aesthetic through use of a slim aesthetic design with a glossy finish, a shield-shaped front frame member, an aerodynamic manual brake fin, a communication device support member, and at least one detachable decorative panel that cover a slim floor platform and shield-shaped front frame member.

The electric vehicle further utilizes an accelerator handle and a brake handle differentiated by color. This allows for easy recognition of the acceleration and braking means while operating the electric vehicle at high speeds or while distracted. The electric vehicle is also operable as a plug-in electric vehicle with two or three wheels, harnessing electricity that is stored on board in a rechargeable battery to drive an electric motor. The electric motor is operable in the wheels, such as the front wheel. The electric vehicle also provides an On/Off digital locking system that inhibits unauthorized starting of the electric motor. A daytime running lamp automatically switches on when the electric vehicle is moving, emitting white, yellow, or amber light to increase the conspicuity of the electric vehicle during both daylight and night hours.

In addition to the structural novelty, the electric vehicle provides novel wireless connectivity through use of: an integral computer that processes a substantial amount of electrical and communication components of the electric vehicle. The electric vehicle may also include an integrated Wi-Fi hotspot that can be used by multiple communication devices for Internet connectivity. The electric vehicle also utilizes a help button to enable visual and audible communications indicating trouble, i.e., S.O.S. A device charger may also be operational at or near the communication device support member.

The electric vehicle may also include a sound system that includes a speaker for audio navigation and general audio synchronization. The sound system may also include microphones, signal processors, amplifiers, and loudspeakers in enclosures. These audio components may be controlled by a mixing console that makes live or pre-recorded sounds louder and distribute the sounds. The electric vehicle may also include a camera for livestream and/or social media synchronization, and a video streaming device.

The electric vehicle is unique in that the wireless connectivity is controllable through a mobile communication device. Thus, the mobile communication device, such as a smart phone, is in communication with the computer, Wi-Fi hotspot, speaker system, camera, and other wireless connectivity features of the electric vehicle. This creates, in essence, a motorized mobile phone.

In one aspect, an interactive system and method for virtual ride-sharing with electric vehicle, comprises an electric vehicle comprising an in-vehicle camera or mobile communication device capturing vehicle data.

The system may also include an interactive display screen operationally connected to the in-vehicle camera or a mobile communication device, the interactive display screen enabling access, manipulation, and distribution of the vehicle data to a network.

The system may also include a step-through frame comprising a floor platform defined by a front end and a rear end, the floor platform carrying at least two wheels, the wheels being rotatable to advance the electric vehicle. The frame further comprises a steering column extending from the floor platform, the steering column terminating at an accelerator handle and a brake handle, the handles being operatively connected to the wheels, the handles having different colors, whereby manipulating the accelerator handle increases angular velocity of the wheels, and manipulating the brake handle decreases angular velocity of the wheels.

In some embodiments, the frame further comprises a front frame member overlaying the steering column, the front frame member being at least partially transparent. The frame further comprises a manual brake fin operatively connected to the brake handle and at least one of the wheels, whereby the manual brake fin is operable to at least partially restrict rotation of one of the wheels when the brake handle is manipulated. The frame further comprises a communication device support member disposed between the accelerator handle and the brake handle, the communication device support member operable to enable support of the mobile communication device.

In some embodiments, the interactive system comprises a plurality of interchangeable floor panels detachably covering the floor platform. The system may also include a plurality of interchangeable front panels detachably covering the front frame member. The system may also include a rechargeable battery storing electricity, the rechargeable battery disposed between the steering column and the front frame member.

The system may also include a device charger in electrical communication with the rechargeable battery, the device charger being proximal to the communication device support member, whereby the device charger is operable to charge the mobile communication device.

The system may also include an electric motor in electrical communication with the rechargeable battery, the electric motor disposed on or near at least one of the wheels, the electric motor being operatively connected to the accelerator handle and the wheels, whereby the electric motor drives the wheels. The system may also include a digital locking system operatively connected to the electric motor the digital locking system operable to selectively restrict operation of the electric motor.

The system may also include a daytime running lamp disposed between the steering column and the front frame member, the daytime running lamp automatically illuminating when the electric motor is operational, whereby the daytime running lamp illuminates through the at least partially transparent front frame member. The system may also include an integral router forming a Wi-Fi hotspot, the Wi-Fi hotspot operable to enable Internet connectivity for the mobile communication device.

The system may also include a help switch transmitting a signal, the signal indicating irregular events at or near the electric vehicle. The system may also include a sound system generating and mixing sound. The system may also include a global positioning system integral in the frame. The system may also include an integral computer operable to regulate at least one of the following: in-vehicle camera or mobile communication device, the interactive display screen, and the electrical connections, the integral computer further being operable to process the vehicle data and wireless communications, the integral computer further being in communication with the network and the mobile communication device through the Wi-Fi hotspot.

In another aspect, the in-vehicle camera is integrated in the front frame member or the steering column.

In another aspect, the interactive display screen comprises a touch screen.

In another aspect, the vehicle data includes at least one of the following: images and videos of current and previous trips, trip information, including duration, fuel consumption, distance traveled, destination, current vehicle location, infotainment features, streaming audio, in-vehicle photos, vehicle diagnostic information, and vehicle navigation system information.

In another aspect, the network comprises a social media site and the Internet.

In another aspect, the mobile communication device is operable to upload the vehicle data, download the vehicle data, post riding images, livestream the vehicle data, and interact with others on the network while operating the electric vehicle.

In another aspect, the frame is defined by a glossy finish.

In another aspect, the vehicle further comprises a reflector affixed to the front frame member.

In another aspect, the front frame member has an elongated, rectangular shape.

In another aspect, the steering column is about 45″ long.

In another aspect, the floor platform is about 40″ long.

In another aspect, the rechargeable battery receives a power charge from an external power source.

In another aspect, the rechargeable battery includes at least one of the following: a Lithium-Ion Battery, a Nickel-Metal Hydride Battery, a Lead-Acid Battery, and an Ultracapacitor.

In another aspect, the accelerator handle and the brake handle form grips.

In another aspect, the communication device support member is flat.

In another aspect, the device charger comprises a retractable cord.

In another aspect, the mobile communication device comprises a smart phone.

In another aspect, the interchangeable floor panels include multiple colors and designs.

In another aspect, the interchangeable front panels include multiple colors and designs.

In another aspect, the sound system includes at least one of the following: a speaker, a mixer, a microphone, a signal processor, an amplifier, and a loudspeaker.

In another aspect, the camera is disposed at or near the front frame member.

In another aspect, the camera is operable to enable livestream viewing of the area near the electric vehicle, and further operable to enable social media synchronization.

In another aspect, the help switch is a button.

In another aspect, the signal is generated by depressing the button.

In another aspect, the signal from the help switch transmits to a vehicle repair receiver, or a law enforcement receiver, or a medical assistance receiver.

In another aspect, the manual brake fin has an aerodynamic shape.

In another aspect, the camera can be either in-vehicle, mounted or attached, and removable from the electric vehicle.

One objective of the present invention is to provide an electric vehicle that is operable as a mobile communication device, computer, and multi-media system, and that allows a vehicle operator to share a digital riding experience on a social media site and the Internet.

Another objective is to provide an interactive display that allows the vehicle operator to upload content, download content, post riding images, livestream content, and interact with others on social media and the Internet while operating the electric vehicle.

Another objective is to allow the vehicle operator to safely upload videos and images to the social media site while simultaneously operating the electric vehicle.

Another objective is to provide interchangeable, ornamental panels to cover the frame of the electric vehicle.

Yet another objective is to enable support and recharging for a smart phone or tablet directly on the electric vehicle.

Yet another objective is to help a vehicle operator visually discern the accelerator from the brake through use of color-coded handles.

Yet another objective is to provide an electric motor hidden in the wheels.

Yet another objective is to provide an inexpensive to manufacture mobile connectivity and self-generating illumination electric vehicle.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates an interactive system for virtual ride-sharing for an electric vehicle, showing an interactive display displaying an uploaded image of the electric vehicle, in accordance with an embodiment of the present invention;

FIG. 2 illustrates a perspective view of an exemplary mobile connectivity and self-generating illumination electric vehicle in communication with a mobile communication device, in accordance with an embodiment of the present invention;

FIG. 3 illustrates a front perspective view of an exemplary mobile connectivity and self-generating illumination electric vehicle, in accordance with an embodiment of the present invention;

FIG. 4 illustrates a rear perspective view of the mobile connectivity and self-generating illumination electric vehicle shown in FIG. 3, in accordance with an embodiment of the present invention;

FIG. 5 illustrates a side view of the mobile connectivity and self-generating illumination electric vehicle shown in FIG. 3, emitting a signal from a Wi-Fi hotspot, in accordance with an embodiment of the present invention;

FIG. 6 illustrates a rear perspective view of the mobile connectivity and self-generating illumination electric vehicle with interchangeable front panels and floor panels, in accordance with an embodiment of the present invention;

FIG. 7 illustrates a top view of the mobile connectivity and self-generating illumination electric vehicle shown in FIG. 3, in accordance with an embodiment of the present invention;

FIG. 8 illustrates a frontal view of the mobile connectivity and self-generating illumination electric vehicle shown in FIG. 3, in accordance with an embodiment of the present invention;

FIG. 9 illustrates a rear view of the mobile connectivity and self-generating illumination electric vehicle shown in FIG. 3, in accordance with an embodiment of the present invention;

FIGS. 10A and 10B illustrate an alternative electric vehicle converted to an electric bike through a modular chassis, where FIG. 10A shows the electric vehicle and FIG. 10B shows the electric bike, in accordance with an embodiment of the present invention;

FIGS. 11A, 11B, 11C, 11D illustrate different variations of the vertical LED headlight, in accordance with an embodiment of the present invention;

FIG. 12 illustrates an exemplary security key for operation of the electric scooter, in accordance with an embodiment of the present invention; and

FIG. 13 illustrates a flowchart of an exemplary method for virtual ride-sharing with an electric vehicle, in accordance with an embodiment of the present invention.

Like reference numerals refer to like parts throughout the various views of the drawings.

### DETAILED DESCRIPTION OF THE INVENTION

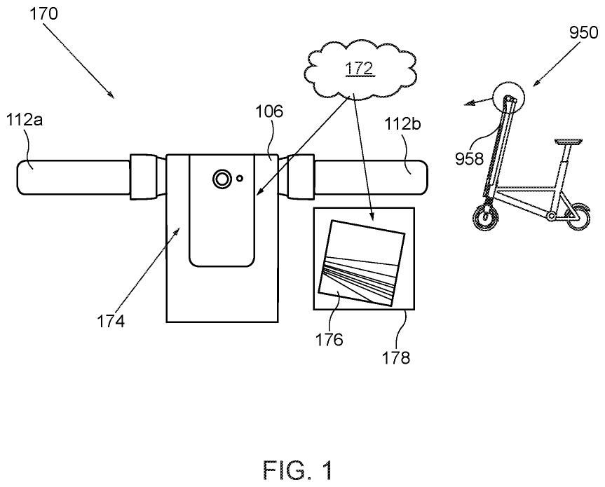

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An interactive system 170 and method 1300 for virtual ride-sharing with electric vehicle is referenced in FIGS. 1-13. The interactive system 170 for virtual ride-sharing with electric vehicle, hereafter “system 170” is unique in that a vehicle operator 180 can operate an electric vehicle 100 and simultaneously share the riding experience on a network 172 directly from the electric vehicle 100 through use of an in-vehicle camera 122, a mobile communication device 174, and an interactive display screen 178 that collect, manipulate, and distribute a vehicle data 176 for consumption by public and private members of the network.

In some embodiments, the electric vehicle 100 may include, without limitation, an electric scooter, an electric bike, an electric moped, an electric off-road vehicle, a small electric car, an electric boat, and an electric airplane. The network 172 may include, without limitation, a social media site, a riding enthusiast forum, a business forum site, and the Internet having both public and private co-users. The vehicle data 176 may include, without limitation, images and videos of current and previous trips; trip information; including duration; fuel consumption; distance traveled; destination; current vehicle location; infotainment features; streaming audio; in-vehicle photos; vehicle diagnostic information; and vehicle navigation system information.

As FIG. 1 references, the interactive system 170 allows a vehicle operator 180 to operate the electric vehicle 100, such as an electric scooter, while simultaneously interacting with network users and sharing a riding experience through a social media site and the Internet directly from the electric vehicle. In some embodiments, the electric scooter 100 is operable to be ridden by a vehicle operator 180 and, in some cases, a passenger with the operator. Both the vehicle operator and passenger may interact with the network 172.

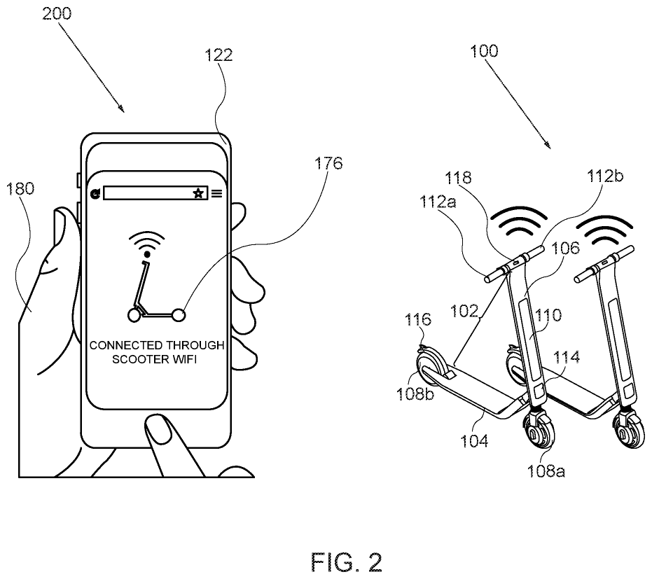

As FIG. 2 shows, the electric vehicle 100 may include an in-vehicle camera 122 or a mobile communication device 174 that captures vehicle data 176. The vehicle data 176 may then be posted to a network, such as a social media site, on-line forum, and the Internet. The in-vehicle camera 122 or the mobile communication device 174 may be integrated in the front frame member 106 or steering column 126 of the electric vehicle, so as to enable the image or video of the road ahead, the road behind, or the vehicle operator to be captured. These images may then be uploaded through an integral computer 142 and the display screen 178 for viewing on the network 172. In some embodiments, the camera 122 can be either in-vehicle, mounted or attached, and removable from the electric vehicle.

Looking back at FIG. 1, the vehicle data 176 may include, without limitation, images and videos of current and previous trips; trip information; including duration; fuel consumption; distance traveled; destination; current vehicle location; infotainment features; streaming audio; in-vehicle photos; vehicle diagnostic information; and vehicle navigation system information. Actually any images, videos, and audio captured may be incorporated into the vehicle data 176.

The interactive system 170 further provides an interactive display screen 178 that the vehicle operator can interact with to view, upload, and livestream the vehicle data 176. The interactive display screen 178 may have a computer, receiver, satellite transmitter and other communication devices used for transmitting data to a remote server or network. The interactive display screen 178 may include, without limitation, a digital touch screen, or a push button display. The interactive system 170 is configured to enable social networking functions to be incorporated into the interactive display screen 178. This generates output for display on social media sites and the Internet.

Thus, the vehicle operator can perform social networking functions, including, uploading content, downloading content, posting riding images, livestreaming content, and interacting with others on social media and the Internet while operating the electric vehicle. For example, the vehicle operator can upload a trip in real time to be viewed on a social media site. Or the vehicle operator can face the in-vehicle camera 122 and speak to an audience on a riding enthusiast forum or YouTube™ while operating the electric vehicle 100.

Looking ahead to FIG. 13, a flowchart of an exemplary method 1300 for virtual ride-sharing with an electric vehicle is configured to enable a vehicle operator to operate the electric vehicle 100 while simultaneously interacting with network users to share a riding experience through a network, such as a social media site, online forum, and the Internet, directly from the electric vehicle. The method 1300 for virtual ride-sharing with an electric vehicle comprises an initial Step 1302 of mounting, by a vehicle operator, an electric vehicle, the electric vehicle comprising an electric motor, a step-through frame, a front frame member, a steering column, and a floor platform carrying at least two wheels operatively connected to the electric motor, the wheels rotatable to advance the electric vehicle.

The method may further comprise a Step 1304 of engaging an accelerator handle to actuate the electric motor, whereby the electric vehicle advances. The vehicle operator 180 depresses the accelerator handle to the desired acceleration. A brake handle also allows the electric vehicle 100 to decelerate to a stop. A Step 1306 includes orienting an in-vehicle camera in a desired direction and position. In addition a personal communication device may also be supported on the front frame member to capture the vehicle data as images, videos, and audio signals.

In some embodiments, a Step 1308 comprises capturing a vehicle data through the in-vehicle camera, whereby the vehicle data shows operation of the electric vehicle. This may include capturing video of the front of the electric vehicle as it is driving. Or an image of the vehicle operator 180. Or an image of the surrounding area. A Step 1310 includes monitoring, by the vehicle operator, the vehicle data through an interactive display screen, the interactive display screen operational on the front frame member or the steering column of the electric vehicle.

In some embodiments, a Step 1312 may include uploading, through the interactive display screen, the vehicle data to a network. The interactive display screen may have a computer, receiver, satellite transmitter and other communication devices used for transmitting data to a remote server or network. A Step 1314 comprises livestreaming the interactive display screen, the vehicle data to a network. A final Step 1316 includes viewing, by an observer, the vehicle data. The observer may include a member of the network, such as a social media friend, a family member, a forum member, or the general public. The vehicle operator and the observer may communicate and interact in response to the vehicle data.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Looking again at FIG. 2, the interactive system 170 is unique in that it provides both transportation and communication means simultaneously. The vehicle 100 is operable with a mobile communication device 200 that controls multiple electrical and wireless communication components used in the vehicle 100. The vehicle 100 is also designed with aesthetics in mind, providing detachable panels having various colors and designs to enhance appeal; and further providing a glossy finish 130, sleek lines, and a floor platform 104 with a narrow skateboard design.

The electric vehicle 100 is intended for public sharing of mobility (transportation), internet connectivity, and digital culture development. This creates a multi-use transportation means that is ergonomic, aesthetic, and functional for transportation purposes. Further, the electric vehicle is intended for retail to consumers. This allows the general public to benefit from the advantages discussed below.

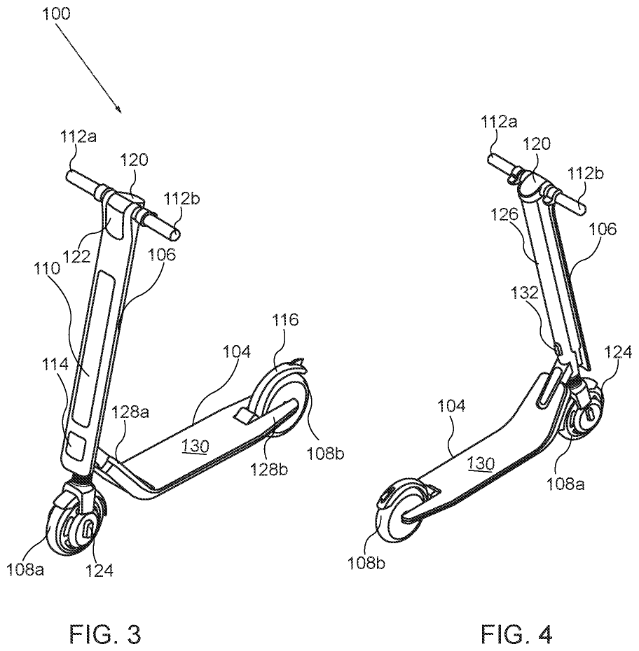

As referenced in FIG. 3, the vehicle 100 comprises a step-through frame 102 for easy loading and unloading. The frame 102 also has a modern, sleek look. The frame 102 is defined by a glossy finish 130 that creates even greater aesthetics. In some embodiments, the frame 102 is coated with a finish that is customizable, provided in various materials generally aluminum, finished in gloss and matte.

In one embodiment, the frame 102 includes a floor platform 104 on which the operator stands. The floor platform 104 is defined by a front end 128a, oriented towards a forward direction and a steering column 126. The floor platform 1094 is also defined by a rear end 128b oriented towards the reverse direction of the vehicle 100, at the manual brake fin 116.

In some embodiments, the floor platform 104 carries at least two wheels 108a, 108b that are rotatable to advance the electric vehicle 100. The wheels 108a, 108b may be a hardened rubber forming a cavity that contains an electric motor 124, or supports an electric motor 124 on the outer surface of a wheel. In one non-limiting embodiment, the floor platform 104 is about 40″ long. In one alternative embodiment, three or four wheels may be used with vehicle 100.

In one non-limiting embodiment, the electric motor 124 utilizes a gearbox which produces different rotation ratio between a drive motor and drive wheels during running of the electric vehicle 100, a differential which serves to absorb a power of the gearbox to overcome rotation speed difference between the drive wheels, and two wheel axles which are used to deliver the power to the drive wheels from the differential. Though other electrical vehicle powering and gear means known in the art may also be used.

As FIG. 4 illustrates, the frame 102 further comprises a steering column 126 extending perpendicularly from the floor platform 104. The operator can turn the steering column in the desired direction during operation of the vehicle. In one non-limiting embodiment, the steering column 126 is about 45″ long. Though in other embodiments, the steering column can be shorter, longer, or even height adjustable.

The steering column 126 terminates at an accelerator handle 112a and a brake handle 112b. The handles 112a-b are operatively connected to the wheels 108a-b, so as to accelerate or decelerate the angular velocity of the wheels 108a-b; and thereby the speed of the vehicle 100. For example, manipulating the accelerator handle 112a increases angular velocity of the wheels 108a, 108b, and manipulating the brake handle 112b decreases angular velocity of the wheels 108a, 108b.

In one non-limiting embodiment, the handles 112a-b are defined by different colors to help visually discern the accelerator from the brake. This color-differentiation can be useful when operating at high speeds or with distractions. Further, the accelerator handle 112a and the brake handle 112b form grips that allow the operator to more effectively steer the electric vehicle 100.

In one embodiment, the frame 102 further includes a front frame member 106 that overlays the steering column 126. The front frame member 106 forms the foremost vanguard that protects the operator from wind and debris while operating the vehicle 100 in a forward direction. In one embodiment, the front frame member 106 has an elongated, rectangular shape. The front frame member 106 is flat so as to prevent bugs, wind, and moisture from striking the operator while riding the vehicle 100.

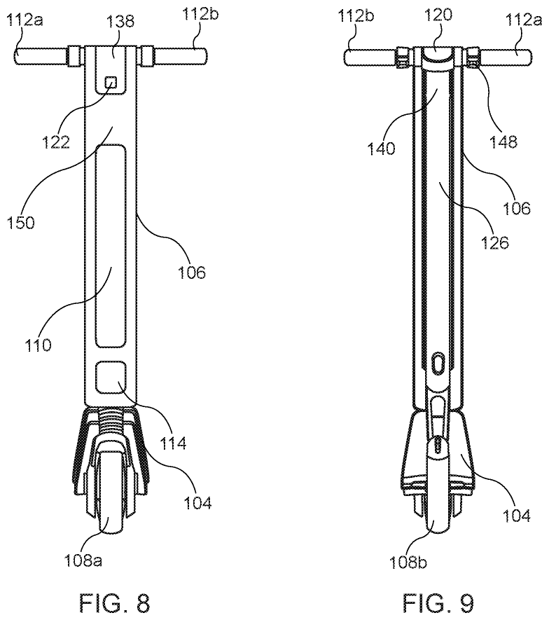

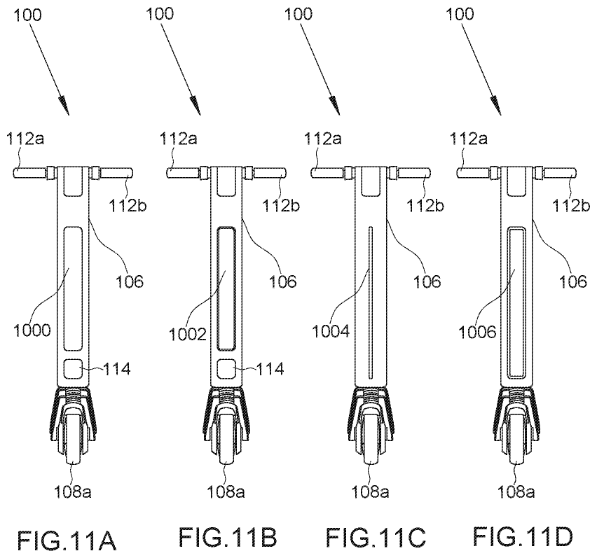

Further, the front frame member 106 is at least partially transparent. The transparent portion of the front frame member 106 may include an elongated window that allows light to pass through (FIGS. 8 and 11A-11D). Though in other embodiments, the entire front frame member 106 is partially opaque. In another embodiment, the front frame member 106 has a vertical-shaped daytime running lamp that illuminates an area in front of the electric vehicle 100.

Turning now to FIG. 4, the frame 102 further comprising a manual brake fin 116 operatively that connects to the brake handle 112b and at least one of the wheels 108a, 108b. The manual brake fin 116 is operable to at least partially restrict rotation of one of the wheels 108a-b when the brake handle 112b is manipulated. In one non-limiting embodiment, the manual brake fin 116 has an aerodynamic shape to further enhance the ornamental effects of the frame 102.

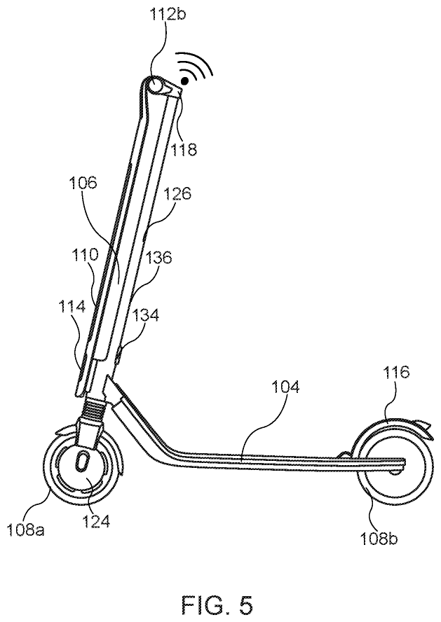

As FIG. 5 references, the frame 102 also includes a communication device support member 120 that is disposed between the accelerator handle 112a and the brake handle 112b. The communication device support member 120 is operable to support of a mobile communication device 200. In one embodiment, the communication device support member 120 is flat. Though in other embodiments, the communication device support member 120 is slightly bowed, so as to cradle the mobile communication device 200. The communication device support member 120 may include a magnet that retains the mobile communication device 200 in a stable position while operating the vehicle 100. This can be useful when the vehicle 100 leans to the left or right, or accelerates quickly.

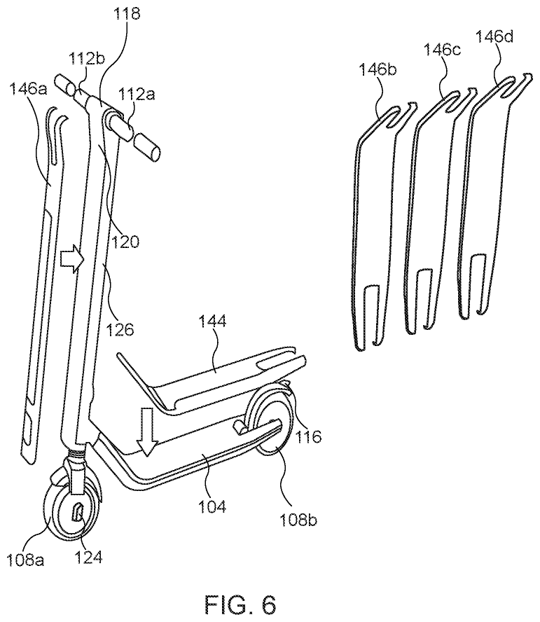

As shown in FIG. 6, the vehicle 100 may further include a plurality of interchangeable floor panels 144 detachably covering the floor platform 104. The floor panels 114 overlay the floor platform 104, providing an additional surface—chiefly for aesthetics. Similarly, a plurality of interchangeable front panels 146a-d detachably cover the front frame member 106. The interchangeable floor panels 144 include multiple colors and designs. FIG. 5 shows a red, white, and blue series of panels 144, 146a-d that enhance the ornamental effect. The floor and front panels 146a-d can snap-on or be fastened through a bolt, screw, or magnet to the frame 102.

In some embodiments, the vehicle 100 comprises a rechargeable battery 132 that stores electricity for powering the electric motor 124. The rechargeable battery 132 must be recharged from time to time. This is typically done by plugging the rechargeable battery 132 into an AC power outlet for some period of time to restore the depleted energy. The rechargeable battery 132 may be disposed between the steering column 126 and the front frame member 106. The rechargeable battery 132 can be a battery pack that is modular and easily concealed in the frame 102. In some embodiments, the rechargeable battery 132 may include, without limitation, a lithium-ion battery, a nickel-metal hydride battery, a lead-acid battery, and an ultra-capacitor. In one embodiment, the rechargeable battery 132 receives a power charge from an external power source.

As discussed above a mobile communication device 200 is operable with the vehicle 100. The mobile communication device 200 may include, without limitation, a smart phone, a tablet, and a laptop. Thus, the vehicle 100 utilizes a device charger 134 that is in electrical communication with the rechargeable battery 132 for recharging means. The device charger 134 is proximal to the communication device support member 120. The device charger 134 is operable to charge the mobile communication device 200. In one non-limiting embodiment, the device charger 134 comprises a retractable cord 136 that extends the reach for recharging.

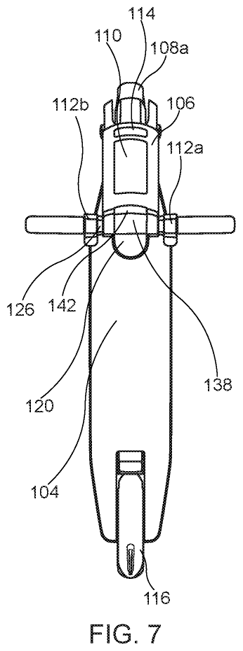

As FIG. 7 shows, the electric motor 124 is in electrical communication with the rechargeable battery 132. The electric motor 124 may be disposed on or near at least one of the wheels 108a, 108b. As the figure shows, the electric motor 124 is encased in a hard cover on the surface of the wheel. Though in other embodiments, the electric motor 124 may be inside the wheel, or adjacent to the wheel. The electric motor 124 being operatively connected to the accelerator handle 112a and the wheels 108a-b, whereby the electric motor 124 drives the wheels 108a-b.

In some embodiment, the vehicle 100 utilizes a digital locking system 148 as a security feature to prevent unauthorized users. The digital locking system 148 is configured to operatively connect to the electric motor 124, so as to selectively restrict operation of the electric motor 124. The digital locking system 148 may include an On/Off switch that is locked and unlocked through a code or a physical key.

As the frontal view of vehicle 100 in FIG. 8 references, a daytime running lamp 110 is operable to face the front of the vehicle 100, illuminating through the front frame member 106. The daytime running lamp 110 automatically illuminates when the electric motor 124 is operational. The daytime running lamp 110 does not draw energy from the rechargeable battery 132 due to the self-generating functionality. The front frame member 106 may be elongated and have a vertical shape to support the daytime running lamp 110.

In one embodiment, the daytime running lamp 110 is disposed between the steering column 126 and the front frame member 106. The daytime running lamp 110 illuminates through the transparent front frame member 106. In one non-limiting embodiment, the vehicle 100 further comprises a reflector 114 affixed to the front frame member 106. The reflector 114 also provides safe visibility of the vehicle 100; especially in the dark. The reflector may have multiple shiny, colorful colors that reflect light to draw attention to the vehicle.

FIGS. 11A-11D illustrate different variations of the vertical LED headlight. FIG. 11A shows electric scoter 100 having a first embodiment daytime running lamp 1000 with elongated and wide configuration, above a reflector 114. FIG. 11B shows electric scoter 100 having a second embodiment daytime running lamp 1002 with elongated perimeter lighting and wide configuration, above a reflector 114. FIG. 11C shows electric scoter 100 having a third embodiment daytime running lamp 1004 with elongated lighting and thin configuration, not utilizing a reflector 114. FIG. 11D shows electric scoter 100 having a fourth embodiment daytime running lamp 1006 with elongated perimeter lighting, not utilizing a reflector 114.

As discussed above, the vehicle 100 operates as a mobile transportation and communication mechanism. The vehicle 100 can be driven, while also enabling wireless communications. For this function, the vehicle 100 utilizes an integral router 118 that forms a Wi-Fi hotspot. The Wi-Fi hotspot is operable to enable Internet connectivity for the mobile communication device 200.

Turning now to FIG. 9, the vehicle 100 is also useful and effective for helping when an irregular event occurs. The event may include an accident, a mechanical breakdown, a robbery, and a natural disaster. In some embodiments, the operator manipulates the help switch 140 to generate a signal. The help switch 140 transmits a signal when an irregular events occurs at or near the electric vehicle 100. In one embodiment, the signal from the help switch 140 transmits to a vehicle repair receiver, or a law enforcement receiver, or a medical assistance receiver. In one non-limiting embodiment, the signal is generated by depressing a button near the steering column 126.

The vehicle 100 also provides a unique sound system 138 that generates and mixes sound, including audio tapes, music, and other audible entertainment or instructive media. The sound system 138 allows the operator to listen to audio while operating the vehicle 100. In some embodiments, the sound system 138 may include, without limitation, a speaker, a mixer, a microphone, a signal processor, an amplifier, and a loudspeaker. The mobile communication device 200 can be used to operate the sound system 138.

Looking back at FIG. 3, the vehicle 100 also includes a camera 122 that captures video and images from the front of the vehicle 100, such as from the front frame member 106. In some embodiments, the camera 122 is disposed at or near the front frame member 106. Though in other embodiments, the camera 122 can be at the sides or rear of the frame 102 to capture different vantage points. In some embodiments, the camera 122 may by operable to enable livestream viewing of an area near the electric vehicle 100. The camera 122 also captures video and images to enable social media synchronization. For example, captured pictures can be uploaded on a social media site, or any website in general. Thus in one possible embodiment, the vehicle 100 is a social media broadcasting system.

For example, the mobile communication device 200 commands the camera 122 to capture an image and upload the image to a social media site. In one alternative embodiment, an external camera operatively attaches to the electric vehicle and/or electric bike discussed below. The bike and uses the captured image or video to publish, stream, or upload pictures and videos to the public, internet, social media sites. Thus, a user may show live videos of a journey taken by the electric vehicle on a social media site, such as Facebook™, or on the user's personal website. The user can upload the image or video directly from the electric vehicle, or wait till later to upload after editing the image or video.

Additionally, the mobile communication device 200 commands the sound system 138 to play a music track. The sound may be combined with the video and uploaded to the social media site, as discussed above. The mobile communication device can also monitor the amount of charge in the battery, the distance traveled, maintenance requirements, Wi-Fi hotspot signal strength, and through the integral GPS 150, find local establishments.

The vehicle 100 further comprises a global positioning system 150 that is integral in the frame 102. The global positioning system 150 provides geolocation and time information to a global positioning system receiver. Through the global positioning system 150 an operator can view the location of the vehicle 100 from a personal mobile communication device 200.

In one exemplary use of the global positioning system 150, the vehicle 100 is equipped with a navigation system that incorporates a global positioning system receiver. The GPS receiver has an antenna to receive signals from a satellite network. The vehicle navigation system uses the satellite positioning signals to compute coordinates that locate the vehicle over the surface of the earth with regard to longitude, latitude, and altitude. The global positioning system 150 is in communication with the mobile communication device 200 to enable the operator to view the position of the vehicle 100. Also, with the appropriate map software, the vehicle's location can then be shown on a map visible on the mobile communication device 200.

The vehicle 100 may include an integral computer 142 that is operable to regulate the electrical connections and process the wireless communications throughout the vehicle 100. The integral computer 142 is also in communication with the mobile communication device 200 through the Wi-Fi hotspot. This allows the computer 142 to tie together the functions of the mobile communication device 200 and the electrical connections and process the wireless communications throughout the vehicle 100. In one embodiment, the computer 142 is a processor or a microchip known in the art.

As referenced back in FIG. 2, the vehicle 100 is unique in that the mobile communication device 200 is in communication with the integral computer 142, the Wi-Fi hotspot, the sound system 138, the camera 122, the help switch 140, and the global positioning system 150. This allows the computer 142 to process data and communicate the processes data to the mobile communication device 200. This also allows the sound system 138 and camera 122 to be controlled through the mobile communication device 200.

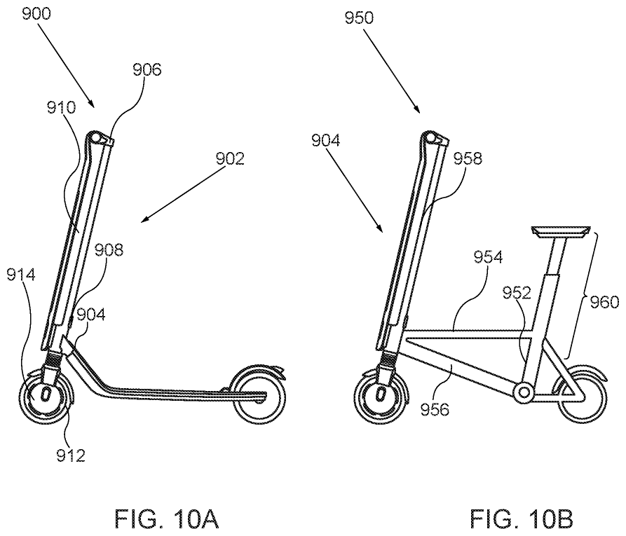

The vehicle 100 is also interchangeable to a bike through use of a modular chassis 902 that contains the primary components thereof. This allows for a modular use of electric vehicle chassis to create an electric bike 950. As shown in FIGS. 10A and 10B, an alternative electric vehicle 900 converts to an electric bike 950 through a modular chassis 902 and a removable seat subassembly 960. FIG. 10A shows the electric vehicle 900. The modular chassis 902 encapsulates the front end of the frame 904, providing a protective cover that encapsulates a steering column 910, a front wheel 912, and a motor 914 contained on or in the front wheel 912. Further, a display screen 906 and a battery 908 are enclosed inside the modular chassis 902.

As FIG. 10B shows, the electric bike 950 also utilizes modular chassis 902 and forms through attachment of the seat subassembly 960 to the frame 904. This may include a telescoping attachment with a frame tube 952 at the center section of the frame. The frame tube 952 extends perpendicularly from a lower frame bar 956. A cross bar 954 may also extend from the lower frame bar 956 to the steering column 958 to provide structural integrity. This configuration allows for easy, single-operator conversion between electric vehicle 900 and electric bike 950.

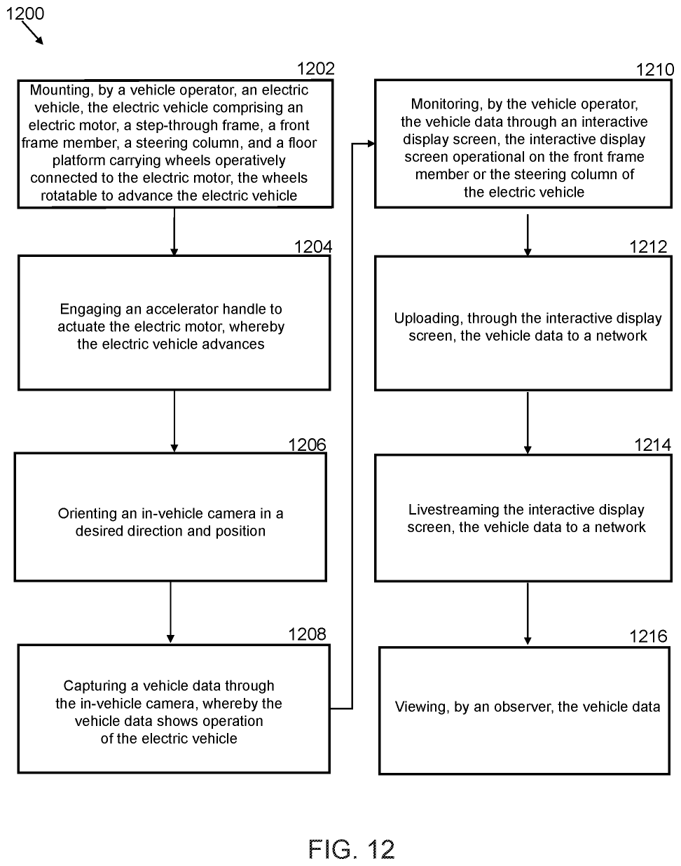

FIG. 12 illustrates an alternative embodiment of electric scooter provides unique security for the scooter 100. In one embodiment, a removable grip 1210 can be removed to prevent operation of the scooter. This prevents unauthorized users from riding the scooter, and also creates interchangeable parts with unique customization. Other security features may include a shape-coded accelerator tab 1208 (triangle) and shape-coded brake switch 1206 (square) to operate scooter. In yet another security feature, the accelerator tab 1208 can be removed so that the scooter is inoperable also. The mobile device mount 1204 can also include an adhesive, or magnet, to prevent the mobile device from sliding off or being stolen. Various mounts can be used in this area.

In another security configuration, the security key enhances access and starting of the motor. The scooter is inoperable when the security key 1200 is removed. In one non-liming embodiment, the security key 1200 includes: a named Mobility Key, a Key to unlock and operate scooter; and a User Identification key having a USB that stores user data, trip data, videos, photos. Additionally, the security key has integrated therein, an NFC tag Integrated universal payment key. The payment key allows the user to scan the key 1200 and pay for items and services. The security key is operable at the steering column 1202, adjacent to the mobile device mount 1204.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A computer-implemented interactive system and method for virtual ride-sharing with electric vehicle, the vehicle comprising:
an electric vehicle comprising:
an in-vehicle camera or mobile communication device capturing vehicle data;
an interactive display screen operationally connected to the in-vehicle camera or a mobile communication device, the interactive display screen enabling access, manipulation, and distribution of the vehicle data to a network;
a step-through frame comprising a floor platform defined by a front end and a rear end, the floor platform carrying at least two wheels, the wheels being rotatable to advance the electric vehicle,
the frame further comprising a steering column extending from the floor platform, the steering column terminating at an accelerator handle and a brake handle, the handles being operatively connected to the wheels, the handles having different colors, whereby manipulating the accelerator handle increases angular velocity of the wheels, and manipulating the brake handle decreases angular velocity of the wheels,
the frame further comprising a front frame member overlaying the steering column, the front frame member being at least partially transparent,
the frame further comprising a manual brake fin operatively connected to the brake handle and at least one of the wheels, whereby the manual brake fin is operable to at least partially restrict rotation of one of the wheels when the brake handle is manipulated, the frame further comprising a communication device support member disposed between the accelerator handle and the brake handle, the communication device support member operable to enable support of the mobile communication device;
a plurality of interchangeable floor panels detachably covering the floor platform;
a plurality of interchangeable front panels detachably covering the front frame member;
a rechargeable battery storing electricity, the rechargeable battery disposed between the steering column and the front frame member;
a device charger in electrical communication with the rechargeable battery, the device charger being proximal to the communication device support member, whereby the device charger is operable to charge the mobile communication device;
an electric motor in electrical communication with the rechargeable battery, the electric motor disposed on or near at least one of the wheels, the electric motor being operatively connected to the accelerator handle and the wheels, whereby the electric motor drives the wheels;
a digital locking system operatively connected to the electric motor the digital locking system operable to selectively restrict operation of the electric motor;
a daytime running lamp disposed between the steering column and the front frame member, the daytime running lamp automatically illuminating when the electric motor is operational, whereby the daytime running lamp illuminates through the at least partially transparent front frame member;
an integral router forming a Wi-Fi hotspot, the Wi-Fi hotspot operable to enable Internet connectivity for the mobile communication device;
a help switch transmitting a signal, the signal indicating irregular events at or near the electric vehicle;
a sound system generating and mixing sound;
a global positioning system integral in the frame;
a security key;
an integral computer operable to regulate at least one of the following: the in-vehicle camera or the mobile communication device, the interactive display screen, and the electrical connections, the integral computer further being operable to process the vehicle data and wireless communications, the integral computer further being in communication with the network and the mobile communication device through the Wi-Fi hotspot.

2. The system of claim 1, wherein the electric vehicle comprises an electric scooter.

3. The system of claim 1, wherein the in-vehicle camera is integrated in the front frame member or the steering column, in-vehicle, mounted or attached, and removable from the electric vehicle.

4. The system of claim 1, wherein the in-vehicle camera is operable to enable livestream viewing of the area near the electric vehicle, and further operable to enable social media synchronization.

5. The system of claim 1, wherein the interactive display screen comprises a touch screen.

6. The system of claim 1, wherein the vehicle data includes at least one of the following: images and videos of current and previous trips, trip information, including duration, fuel consumption, distance traveled, destination, current vehicle location, infotainment features, streaming audio, in-vehicle photos, vehicle diagnostic information, and vehicle navigation system information.

7. The system of claim 1, wherein the mobile communication device is operable to upload the vehicle data, download the vehicle data, post riding images, livestream the vehicle data, and interact with the network.

8. The system of claim 1, wherein the network comprises a social media site and the Internet.

9. The system of claim 1, further comprising a plurality of interchangeable floor panels detachably covering the floor platform and the front frame member.

10. The system of claim 1, further comprising a global positioning system integral in the frame, the global positioning system providing a geolocation and time information about the electric vehicle.

11. The system of claim 1, further comprising a digital locking system operatively connected to the electric motor.

12. The system of claim 1, further comprising a reflector affixed to the front frame member.

13. The system of claim 1, wherein the steering column is about 45 inches long, and the floor platform is about 40 inches long.

14. The system of claim 1, wherein the rechargeable battery includes at least one of the following: a lithium-ion battery, a nickel-metal hydride battery, a lead-acid battery, and an ultracapacitor.

15. The system of claim 1, wherein the device charger comprises a retractable cord.

16. The system of claim 1, wherein the sound system includes at least one of the following: a speaker, a mixer, a microphone, a signal processor, an amplifier, and a loudspeaker.

17. The system of claim 1, wherein the signal from the security key includes at least one of the following: a named Mobility Key, a User Identification key having USB, and an NFC tag integrated universal payment key.

18. A computer-implemented interactive system and method for virtual ride-sharing with electric vehicle, the vehicle comprising:
an electric scooter comprising:
an in-vehicle camera or mobile communication device capturing vehicle data, the vehicle data including at least one of the following: images and videos of current and previous trips, trip information, including duration, fuel consumption, distance traveled, destination, current vehicle location, infotainment features, streaming audio, in-vehicle photos, vehicle diagnostic information, and vehicle navigation system information;
an interactive display screen operationally connected to the in-vehicle camera or a mobile communication device, the interactive display screen enabling access, manipulation, and distribution of the vehicle data to a network;
a step-through frame comprising a floor platform defined by a front end and a rear end, the floor platform carrying at least two wheels, the wheels being rotatable to advance the electric vehicle,
the frame further comprising a steering column extending from the floor platform, the steering column terminating at an accelerator handle and a brake handle, the handles being operatively connected to the wheels, the handles having different colors, whereby manipulating the accelerator handle increases angular velocity of the wheels, and manipulating the brake handle decreases angular velocity of the wheels,
the frame further comprising a front frame member overlaying the steering column, the front frame member being at least partially transparent,
the frame further comprising a manual brake fin operatively connected to the brake handle and at least one of the wheels, whereby the manual brake fin is operable to at least partially restrict rotation of one of the wheels when the brake handle is manipulated, the frame further comprising a communication device support member disposed between the accelerator handle and the brake handle, the communication device support member operable to enable support of the mobile communication device;
a plurality of interchangeable floor panels detachably covering the floor platform;
a plurality of interchangeable front panels detachably covering the front frame member;
a rechargeable battery storing electricity, the rechargeable battery disposed between the steering column and the front frame member;
a device charger in electrical communication with the rechargeable battery, the device charger being proximal to the communication device support member, whereby the device charger is operable to charge the mobile communication device;
an electric motor in electrical communication with the rechargeable battery, the electric motor disposed on or near at least one of the wheels, the electric motor being operatively connected to the accelerator handle and the wheels, whereby the electric motor drives the wheels;
a digital locking system operatively connected to the electric motor the digital locking system operable to selectively restrict operation of the electric motor;
a daytime running lamp disposed between the steering column and the front frame member, the daytime running lamp automatically illuminating when the electric motor is operational, whereby the daytime running lamp illuminates through the at least partially transparent front frame member;
an integral router forming a Wi-Fi hotspot, the Wi-Fi hotspot operable to enable Internet connectivity for the mobile communication device;
a help switch transmitting a signal, the signal indicating irregular events at or near the electric vehicle;
a sound system generating and mixing sound;
a security key, the security key including at least one of the following: a named Mobility Key, a User Identification key having a USB, and an NFC tag Integrated universal payment key;
a global positioning system integral in the frame; and
an integral computer operable to regulate at least one of the following: the in-vehicle camera or the mobile communication device, the interactive display screen, and the electrical connections, the integral computer further being operable to process the vehicle data and wireless communications, the integral computer further being in communication with the network and the mobile communication device through the Wi-Fi hotspot, whereby the mobile communication device is operable to upload the vehicle data, download the vehicle data, post riding images, livestream the vehicle data, and interact with the network.

19. The system of claim 18, wherein the in-vehicle camera is integrated in the front frame member or the steering column.

20. A computer-implemented method for virtual ride-sharing with an electric vehicle, the method comprising:
mounting, by a vehicle operator, an electric vehicle, the electric vehicle comprising an electric motor, a step-through frame, a front frame member, a steering column, and a floor platform carrying at least two wheels operatively connected to the electric motor, the wheels rotatable to advance the electric vehicle;
engaging an accelerator handle to actuate the electric motor, whereby the electric vehicle advances;
orienting an in-vehicle camera in a desired direction and position;
capturing a vehicle data through the in-vehicle camera, whereby the vehicle data shows operation of the electric vehicle;
monitoring, by the vehicle operator, the vehicle data through an interactive display screen, the interactive display screen operational on the front frame member or the steering column of the electric vehicle;
uploading, through the interactive display screen, the vehicle data to a network;
livestreaming the interactive display screen, the vehicle data to a network; and
viewing, by an observer, the vehicle data.
